(19) United States
(12) Patent Application Publication
(10) Pub. No.: US 2022/0170291 A1
(43) Pub. Date: Jun. 2, 2022

(54) FENCE POST LAYOUT SYSTEMS AND METHODS

(71) Applicant: N. Eric Knudsen, Maple Valley, WA (US)

(72) Inventor: N. Eric Knudsen, Maple Valley, WA (US)

(21) Appl. No.: 17/540,987

(22) Filed: Dec. 2, 2021

Related U.S. Application Data
(60) Provisional application No. 63/120,668, filed on Dec. 2, 2020.

(51) Int. Cl. E04H 17/20; E04H 17/26

(52) U.S. Cl. CPC E04H 17/20; E04H 17/263

(57) ABSTRACT

A fence post layout system and method includes a measurement device to collect data corresponding to a length of a fence run and presenting a visual representation of the length of the fence run to an operator through a user interface. The measurement device also collects data corresponding to installation site characteristics, such as topography. The system analyzes the installation site data to determine fence post spacing and fence post installation locations along the fence run and outputs a visual representation to the operation of the fence post installation locations via the user interface.

### BACKGROUND

### Technical Field

The present disclosure relates to fence posts, and more particularly, to systems and methods for laying out fence post locations at an installation site.

### Description of the Related Art

Fences are ubiquitous in modern society, used in a vast range of applications, to mark and accent boundaries, provide security, and control movement of people and animals. Thousands of miles of new and replacement fences are installed every year, and utilize vast amounts of construction-related natural resources.

FIG. 1 shows a landscape with a fence 100 extending along portions thereof. The fence 100 shown in FIG. 1 comprises two major segments, or runs, 102. A run is a section or portion of a fence that extends between natural dividing points such as corners, gates, buildings, etc. Except where a fence is attached to a building, each run 102 generally has a main post 104a at each end and line posts 104 spaced between the main posts. Each pair of adjacent posts 104 has a fence panel 106 coupled between them. Each panel 106 comprises horizontal elements, or rails, 108, and vertical elements, or fence boards, 110. Although each of the fence panels 106 are shown as straight sections with horizontal rails 108, it is appreciated that rails 108 may be installed at oblique angles relative to the posts 104 to adapt, for example, to various land topographies or obstacles.

Typically, fence construction and installation involves a number of steps. In some cases, a site survey is done to determine the precise location of the fence and to prevent the all-too-common (and potentially very expensive) occurrence of installing a fence a few inches or feet beyond the actual property line. A contractor visits the site to estimate the materials and labor required to build and install the fence. In addition to simply measuring linear feet required, elements such as topography and obstructions must be reviewed and accounted for. If the fence location has not been marked by the owner or surveyor, the contractor may mark the location during the initial visit, or during a later visit. Installation is scheduled, and materials are ordered and delivered to the site.

Depending on the scope of the project, the locations and spacing of the fence posts may be determined and laid out in advance, by a landscape architect, for example, or left to the installation crew to determine on site. In either case, the spacing of the posts is limited by the material available, and typically is selected to make best use of that material. For example, 96 inch lumber is commonly used to frame wooden fences, so the maximum distance between posts cannot exceed 96 inches. On the other hand, if the contractor uses 96 inch lumber, it would be wasteful to set the posts 60 inches apart, which would result in about three feet of waste from every framing rail. However, because of other considerations, some waste is unavoidable. It is generally preferable to evenly space the posts of a given run of fence, to provide an attractive and unified appearance. Inasmuch as such a run will rarely be evenly divisible by eight feet, each post will be something less than eight feet apart.

Additionally, if the terrain includes changes in elevation which the bottom and/or top rail must follow, the length of the angled framing rails between two posts that are at different heights may be much greater than the lateral distance between the posts, which reduces the maximum permissible horizontal distance between any of the posts of that run. Furthermore, it can be difficult, or at least time consuming, to precisely position a post to within a fraction of an inch, so a margin of an inch or two is generally provided. Thus, the posts may be spaced anywhere from a couple of inches to a couple of feet less than the maximum allowable distance. Finally, when building fences from natural materials such a wood, it is not uncommon for individual pieces to be unsuitable, because of, for example, a knot in a position that unacceptably weakens a part, or an excessively warped board, etc. For all of these reasons, some material waste is expected and allowed for in the original estimate when calculating the materials for the frame rails, and, for similar reasons, when calculating materials for fence boards and posts.

In some cases, one or more string lines are arranged at the installation site. The string lines extend along the intended location of the fence runs. The locations and spacing of the fence posts are then determined along the string lines by approximation or in some cases, by using a tape measure. However, this process does not take into account the spacing of the fence posts to reduce waste and also fails to consider the topography at the installation site, which can lead to mistakes during installation and increased costs. Once the materials and crew are at the site, and with post locations marked, the post holes are dug, and the posts are installed. The construction of the fence may then continue in a known manner.

In view of the expense, labor, and waste associated with installing a fence that is custom-built on site, another method of building and installing fences has been introduced. Pre-manufactured fence panels are becoming more available, and increasingly can be found in a wide variety of materials, including wood, vinyl, composite, aluminum, steel, concrete, etc., and in a wide variety of designs. Pre-manufactured fence panels often have a pre-determined size, such as six feet tall by eight feet long. If there any portions of a fence run with a length between posts of less than eight feet, then the installer must cut the panels to fit the distance, which creates waste of the remaining, unused panel or panels. Further, the contractor can install the panels post by post, which is time intensive and increases costs, or can install all of the posts first, but this requires significant care to ensure that the distance between the posts is exactly correct. Otherwise, it may be necessary to trim the panel to fit, or shim the post to fill a gap. Either approach can create issues if a string line is used to set the post location because inaccuracies in the post locations and spacing can create additional work during installation, which increases costs.

### BRIEF SUMMARY

One or more implementations of a method may be summarized as comprising: collecting data corresponding to a length of a fence run using a measurement device; presenting a visual representation of the length of the fence run through a user interface; collecting data corresponding to installation site characteristics along the fence run; analyzing the data corresponding to the installation site characteristics to determine fence post spacing and fence post locations along the fence run; and outputting fence post characteristics through the user interface, including providing a three-dimensional augmented reality visual representation of fence post installation locations along the fence run through the user interface.

The method may further include: collecting data corresponding to the length of the fence run using the measurement device includes using one of a smart phone, tablet, and a wireless electronic device to collect the data; collecting data corresponding to the installation site characteristics includes collecting LIDAR data using a LIDAR sensor of the measurement device, the LIDAR data corresponding to a topography of the installation site; outputting the fence post characteristics includes outputting at least one of fence post height and fence post installation depth; collecting data corresponding to the length of the fence run includes analyzing the data corresponding to the length of the fence run to determine initial fence post spacing and initial fence post locations along the fence run, and analyzing the data corresponding to the installation site characteristics includes adjusting the initial fence post spacing and initial fence post locations based on the data corresponding to the installation site characteristics along the fence run to determine the fence post spacing and fence post locations along the fence run; and collecting data corresponding to installation site characteristics includes collecting photogrammetry data using a camera of the measurement device; and analyzing the photogrammetry data, including determining a topography of the installation site using triangulation of converging lines in space based on the photogrammetry data.

One or more implementations of a computing device may be summarized as comprising: a memory configured to store computer instructions; and at least one processor configured to execute the computer instructions to collect data corresponding to a length of a fence run at an installation site via a measurement device in electronic communication with the at least one processor, determine a straight line distance between a first reference point and a second reference point along the length of the fence run, collect at least one of LIDAR data and photogrammetry data with a sensor of the measurement device along the straight line distance; analyze the at least one of the LIDAR data and the photogrammetry data to determine fence post characteristics along the straight line distance; generate a visual representation of a location of one or more fence posts along the straight line distance and the fence post characteristics; and display a graphical user interface to the user for receiving the visual representation of the location of the one or more fence posts along the straight line distance and the fence post characteristics.

The computing device may further include: the fence post characteristics being at least one of a fence post height and a fence post installation depth; the visual representation being an augmented reality indicator and the graphical user interface being displayed to the user on the measurement device; the measurement device being a smart phone, tablet, or a wireless electronic device including the sensor; the sensor being a LIDAR sensor and the at least one processor being configured to execute the computer instructions to collect the LIDAR data, the LIDAR data including topography information at the installation site; and the sensor being a camera of the measurement device and the at least one processor is configured to execute the computer instructions to collect the photogrammetry data, the photogrammetry data including images captured by the camera and stored on the measurement device, the at least one processor further configured to execute computer instructions to determine a topography of the installation site by triangulating converging lines in space based on the photogrammetry data.

One or more implementations of a computing device may be summarized as comprising: a memory configured to store computer instructions; and at least one processor configured to execute the computer instructions to collect data corresponding to a length of a fence run at an installation site via a measurement device in electronic communication with the at least one processor, determine a straight line distance between a first reference point and a second reference point along the length of the fence run, analyze the data corresponding to the length of the fence run to determine at least one of fence post spacing and fence post installation locations along the fence run, and display a graphical user interface to the user for receiving a three-dimensional augmented reality visual representation of the at least one of fence post spacing and fence post installation locations along the fence run.

The computing device may further include: the at least one processor being further configured to execute computer instructions to collect at least one of LIDAR data and photogrammetry data from a sensor of the measurement device along the straight line distance, analyze the at least one of LIDAR data and photogrammetry data to determine fence post characteristics along the straight line distance, generate a visual representation of the fence post characteristics, and display the graphical user interface to the user for receiving the visual representation of the fence post characteristics; the fence post characteristics being at least one of fence post height and fence post installation depth; the at least one processor being further configured to execute computer instructions to analyze the at least one of the LIDAR data and photogrammetry data to determine topography information of an installation site, and adjust the at least one of the fence post spacing and fence post installation locations based on the topography information; the data corresponding to the length of the fence run being at least one of LIDAR data collected via a LIDAR sensor of the measurement device, photogrammetry data collected via a camera of the measurement device, and GPS data collected by a GPS receiver of the measurement device; the at least one processor being further configured to execute computer instructions to analyze the at least one of LIDAR data, photogrammetry data, and GPS data to determine topography information at the installation site; and the measurement device being a smartphone or a tablet.

### BRIEF DESCRIPTION OF THE SEVERAL VIEWS OF THE DRAWINGS

FIG. 1 shows a landscape with a fence.

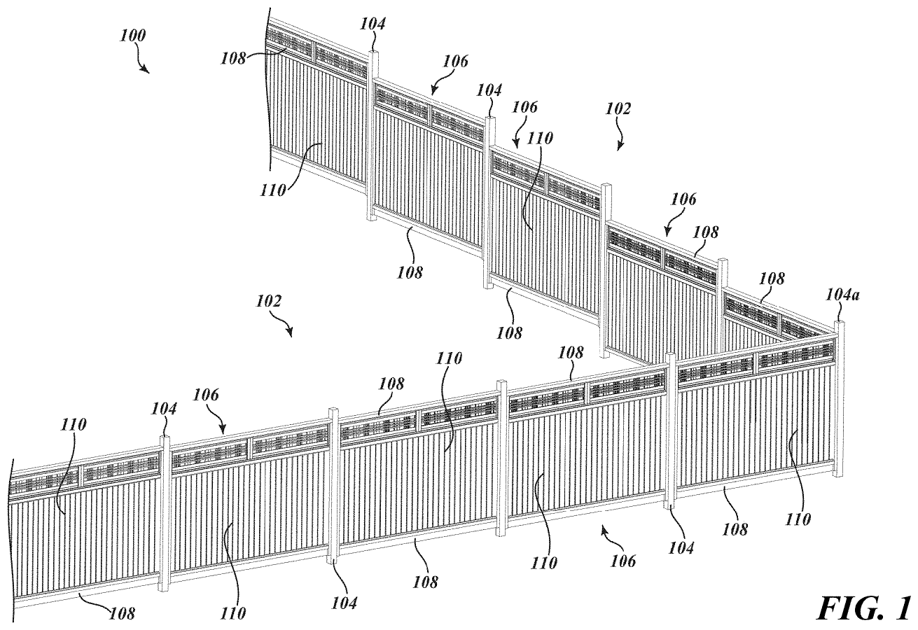

FIGS. 2A-2D show images of a graphical user interface that allows an operator to determine a length of a fence run with a measurement device.

FIG. 3 is a schematic representation of a process for collecting data regarding the length of the fence run, according to one implementation of the present disclosure.

FIG. 4 is a schematic representation of a process for analyzing the fence run data to determine a straight line distance between reference points, according to one implementation of the present disclosure.

FIG. 5 is an image of a graphical user interface that allows an operator to receive information regarding the straight line distance of the fence run, according to one implementation of the present disclosure.

FIGS. 6A-6D show images of the graphical user interface that request input from the operator regarding how to measure and obtain a straight line distance between markers, according to one implementation of the present disclosure.

FIG. 7 is a schematic representation of a process for collecting data regarding the location and spacing of the fence posts, according to one implementation of the present disclosure.

FIG. 8 is a schematic representation of a display of the software once two points of a known run are scanned in and recognized by the software, according to one implementation of the present disclosure.

FIG. 9 is a schematic elevational representation of the process of FIG. 7.

FIG. 10 shows a system diagram that describes one implementation of a computing system according to the present disclosure for performing the implementations described herein.

### DETAILED DESCRIPTION

Techniques for laying out the location of fence posts are provided which utilize LIDAR (light detection and ranging) technology and various algorithms to accurately determine fence post installation locations while taking into account the topography of the installation site, as well as other installation site characteristics. The techniques also include outputting augmented reality projections of the fence post installation locations to a user to assist with accurately marking each fence post location.

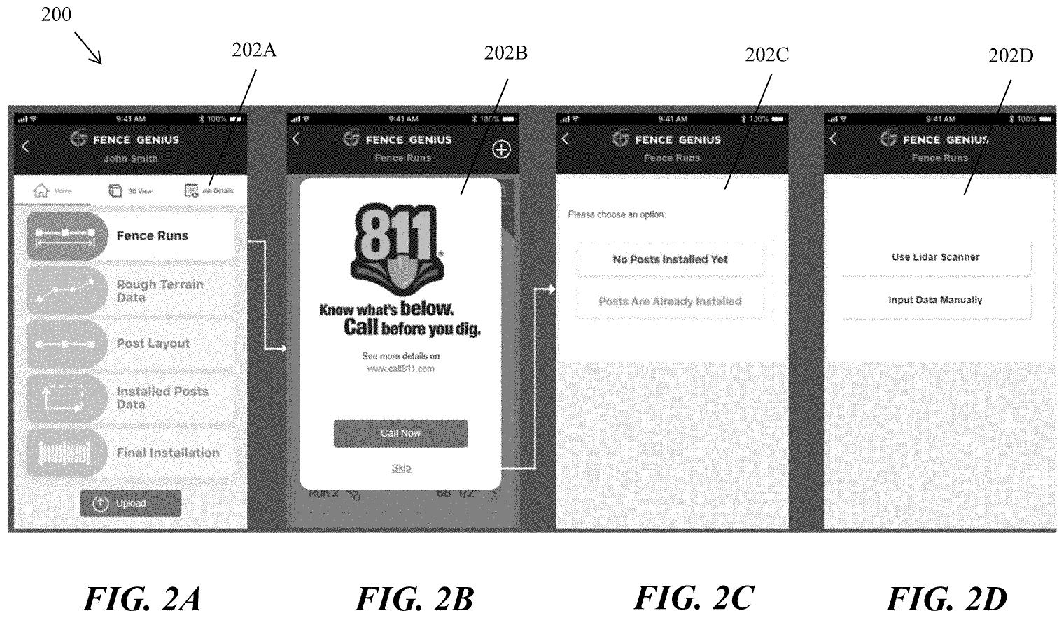

The techniques begin with an operator accessing a software program installed on an electronic device, as described herein. FIGS. 2A-2D show images of a graphical user interface 200 of the software program that allows an operator to determine a length of a fence run with an electronic device that stores and executes the software program. The electronic device may include a camera, accelerometers, and other sensors for determining a measurement based on the inputs described below.

Beginning with FIG. 2A, the interface 200 includes a first image 202A displayed to an operator through a display of a device, such as a smart phone, tablet, or other like wireless electronic device. The image 202A provides several options to the operator, including an option to select the measurement of a fence run. A selection of an icon through the interface 200 can be made by tapping on the icon, or with a stylus or cursor, among other like structures. After a selection is made, the interface presents a different image to the operator with further options.

If the operator selects “fence runs,” a second image 202B of the interface 200 is displayed to the operator, as shown in FIG. 2B. The second image 202B provides a warning to operators to locate utilities before digging holes for fence posts. The second image 202B is optional and may not be included in some implementations of the graphical user interface 200.

After proceeding past the warning in FIG. 2B (or in implementations without the warning), the user interface 200 displays a third image 202C to the operator. The operator selects an icon in a similar manner as described with reference to FIG. 2A. Once the operator selects an appropriate icon, the interface 200 displays a fourth image 200D, which presents an option to use a LIDAR scanner or input data manually for a fence run.

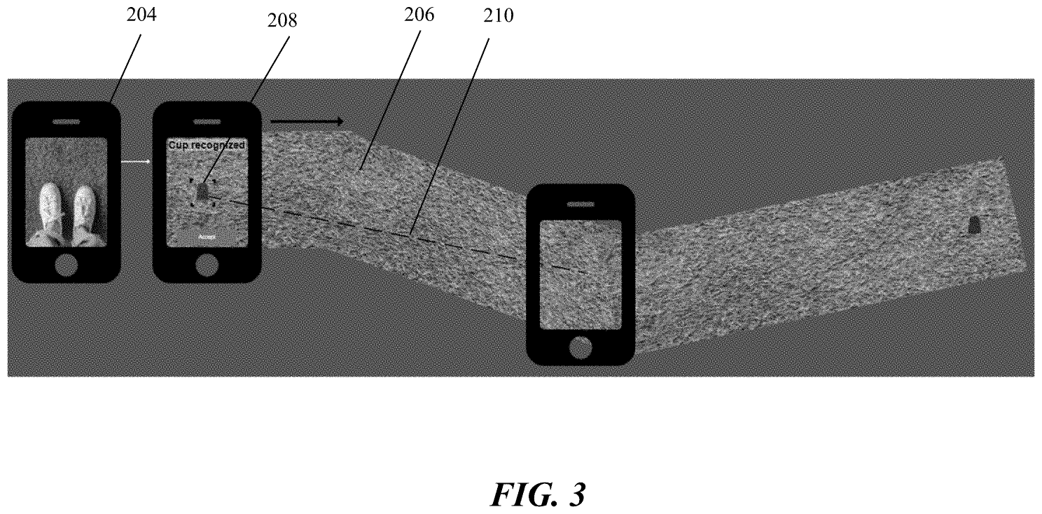

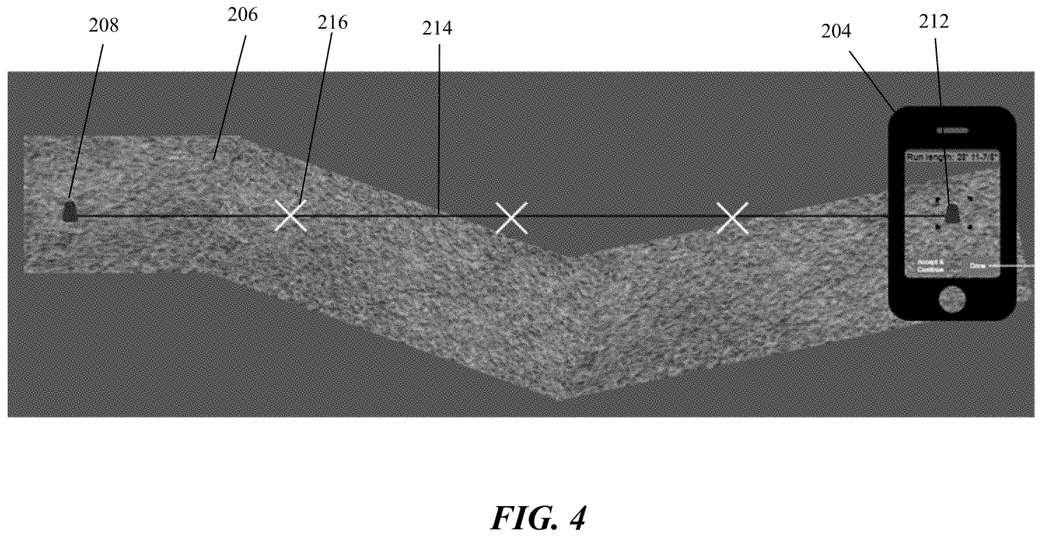

Manual data input may be accomplished by using a string line and a measuring tape and inputting data corresponding to the fence post locations. In some non-limiting examples, manual data input may be useful where the site characteristics and fence post locations are already known, or where an operator is demonstrating the functionality of the software and therefore does not wish to utilize the LIDAR scanner. Selection of the LIDAR scanner option on the screen in image 200D will initiate a scan mode that will be described in greater detail with reference to FIG. 3 and FIG. 4. The exact sequence or the content of the images in FIGS. 2A-2D can be selected and will vary in some implementations according to design factors.

For example, the software described herein may contain some, none, or all of the images shown in FIGS. 2A-2D. In some examples, the software only includes one screen or icon for manipulation by the operator to select LIDAR scanning mode. In some implementations, the software will be implemented in a different form that may not include any of the images in FIGS. 2A-2D, but rather, will perform the basic functionality of fence post spacing, location, and marking, as described herein. Such implementations may include a graphical user interface that proceeds directly to the collection of data described herein without first presenting the operator with any selections as in FIGS. 2A-2D.

LIDAR is a remote sensing method that uses light in the form of a pulsed laser to measure ranges or variable distances to the Earth's surface to provide precise, three-dimensional information about the surface characteristics. In some implementations, a LIDAR instrument includes a laser, a scanner, and a Global Positioning System (“GPS”) receiver. The laser may include a near-infrared laser to map land or a green light laser to measure seafloor and riverbed elevations, in some non-limiting examples. The laser emits laser light pulses, which ping off objects and return to the scanner. The scanner measures distance by timing the travel or flight of the light pulses. The differences in laser return times and wavelengths can then be used to make the three-dimensional representation. LIDAR technology has been included in recent iterations of smartphones, tablets, and other wireless electronic devices to enable augmented reality or virtual reality simulations, among other features. Unless the context clearly dictates otherwise, the software described herein is designed to be stored on, and executed by, an electronic device that includes LIDAR capabilities, including but not limited to smartphones, tablets, and other wireless electronic devices. Although the electronic device may include a wide range of hardware, in general, the software is stored in the memory of the electronic device and executed by a processor of the electronic device.

FIG. 3 is a schematic representation of a process for collecting data regarding the length of the fence run, according to one or more implementations. FIG. 3 illustrates an electronic device 204, illustrated here as a smartphone, that can be used to collect the data. After the user selects LIDAR functionality in FIG. 2D (or through some other process described herein), the electronic device 204 will activate LIDAR functionality on the device 204 as well as a camera on the device 204. The camera view is displayed to the operator through the display of the device 204, as shown. The operator then positions the device 204 to view a ground surface, which may be covered in grass 206 as in FIG. 3. The operator locates the camera of the device 204 over a first marker 208, which may be a cup, a stake, a pole, a flag, a stick, or some other like structure positioned on the ground at the location of a property boundary or at some other selected beginning location for a fence run.

In some implementations, when the software is activated, the device 204 auto detects a shape representing the first marker 208, such as a cup in one non-limiting example, and begins the scanning process based on the detection. Auto detection of the selected shape can also automatically proceed the operator past the screen images shown in FIGS. 2A-2D upon activating the software program, as applicable. The device 204 can be programmed to auto detect a number of different selected shapes in one or more implementations using different image recognition techniques and associated programing languages and protocols, including but not limited to deep learning, computer vision, neural networks, and other like systems and methods. In one or more implementations, the device 204 may also auto detect or recognize a color, a pattern such as a small target in one non-limiting example, as well as other selected features and characteristics of different markers. The device 204 recognizes the first marker 208 and stores a location of the first marker in a memory of the device 204. The operator moves with the device 204 away from the first marker 208 along an intended fence run path as generally indicated by dashed lines 210. The path 210 is not likely to be in a straight line due to variability in the ground surface as well as due to operator error in holding and moving with the device 204. However, the software and the device 204 correct for errors in the path 210, as described with reference to FIG. 4. In some implementations, the device 204 displays the path 210 to the operator on the display of the device 204, such as in a dashed line, which continuously updates as the operator moves along the path 210.

The operator continues to move away from the first marker 208 toward a second marker 212, as shown in FIG. 4. The second marker 212 can be a similar structure to the first marker 208, in some implementations, and is positioned at an intended end point of the fence run. The end point of the fence run may be at a property boundary line, or in some other selected location. Once the operator reaches the second marker 212 and positions the marker 212 in the field of view of the camera of the device 204, the device 204 and the software executed by the device 204 recognize the second marker 212 to determine an end of the fence run. The device 204 then records and stores a location of the second marker 212 in the memory of the device 204.

The first and second markers 208, 212 are reference points that the device 204 can use to determine a straight line distance between the markers 208, 212. The straight line distance is indicated by line 214 in FIG. 4. In some implementations, the device 204 includes a GPS receiver and stores the locations of the markers 208, 212 in GPS coordinates. The device 204 can then execute instructions to calculate the straight line distance 214 between the two points using the GPS coordinates. In some implementations, the device 204 calculates the distance 214 using measurements with the LIDAR system. As the operator moves with the device 204 from the first marker to 208 to the second marker 210, the device 204 is continuously gathering data corresponding to the topography of the ground surface. Further, the device 204 is gathering data corresponding to the time of flight of the laser pulses. The distance 214 between the markers 208, 212 can be calculated using this time of flight information.

In some implementations, the device 204 tracks variations with repeated measurements and may also use images captured by the camera to overlay and track movement to determine the distance 214. In some implementations, the device 204 and the software stored and executed on the device 204 utilize photogrammetry without LIDAR to determine the distance 214. The device 204 captures images at a selected interval, such as one, two, three, four, five, six, seven, eight, nine, ten, or more images per second or per minute in some non-limiting examples, as the device 204 moves from the first marker 208 to the second marker 210. The device 204 and the software associated with the device 204 then utilize triangulation to determine the distance 214. In particular, the device 204 tracks and intersects converging lines in space between the images to determine the precise location of the markers 208, 214 as well as the distance 214. The triangulation process may also produce topography information, which in conjunction with other software and processes described herein, allows the device 204 to output fence post height and post installation depths in some implementations. The device 204 and the software associated with the device may also include a bundle adjustment program for triangulating the target points, resecting the images, and self-calibrating the camera, in order to increase the accuracy of the distance 214. The dashed line 210 in FIG. 3 provides an indicator to the operator of the path to return to the original starting point, or marker 208, as the operator scans. Once the second marker 212 is captured, then the solid line 214, which may also be dashed or have some other form, would connect the markers 208, 212 to each other and be displayed to the operator. The operator would then be able to determine if they were deviating off the straight line fence run path with their measurement. In some implementations, the distance 214 is a horizontal distance, although other distance calculations can be made using the collected LIDAR data, such as a distance measurement at any angle, which may be useful when calculating distance over a sloped surface.

In some implementations, the operator can click or tap on the display of the device 204 to set the reference points instead of using the first and second markers 208, 212. The device 204 stores position information to enable calculation of the straight line distance 214 based on the stored beginning and end positions selected by the operator. Further, the device 204 can display to the operator, via the display and graphical interface 200, a visual indicator corresponding to the reference points. In one non-limiting example, the visual indicator is a “X” presented to the operator in augmented reality on the grass 206.

Once the device 204 determines the straight line distance 214, the device 204 can also calculate generic or sample fence post locations indicated in FIG. 4 by “X”s labeled 216, which may also be referred to herein as fence post location indicators 216. The post locations 216 between the markers 208, 210 can be determined by dividing the calculated straight line distance 214 by a set number of intervals based on a selected maximum panel length or post spacing. In other words, if the selected maximum panel length or post spacing is eight feet, the device 204 divides the distance 214 by eight feet and rounds up to the nearest whole integer to determine the number of panels or “spaces” for the distance 214. The number of posts for the determined number of panels can generally be represented as equal to “n+1” where “n” represents the number of panels or spaces. The “+1” accounts for the end posts in the run over the distance 214. Thus, once the number of panels or spaces are determined, the device adds one to generate the total number of fence posts and displays the posts spaced between the panels or spaces.

For example, if the distance 214 is 20 feet and the selected maximum panel length or post spacing is 8 feet, the device 204 will divide 20 feet by 8 feet and round up to the nearest whole integer to determine the number of panels or spaces, which in this case is 3 panels or spaces. Thus, a fence run over the distance 214 will utilize 3 panels with a length of 6.67 feet to span the 20 foot distance in this example. To determine the number of posts, the device 204 adds 1 to the calculation of 3 panels or spaces to determine that the distance 214 requires 4 posts. The device 204 then places and displays one post indicator 216 for each of the 4 posts at the ends of the run and between the panels or spaces.

In some implementations, the device 204 divides the distance 214 into equal sections that are each less than a selected threshold value, such as a threshold of eight feet. The distance in each equal section can therefore also include decimal values. Other processes and calculations can also be used to determine the number of indicators 216 with the above merely being non-limiting examples. For example, the operator may manually enter the end post locations at the markers 208, 214 and the device 204 calculates only the number of panels and the number of interior posts in an optional implementation. The operator may also select the location of the indicators 216 along the line 214 manually, with the device 204 returning an error if the distance between indicators 216 exceeds or is less than selected threshold values, in another non-limiting example. The threshold values may be any number between and including zero feet to eight feet or more, in some implementations. In some implementations, the indicators 216 are displayed to the operator through the device 204 as augmented reality symbols, as described above.

In some implementations, the operator can select the placement of the indicators 216 along the straight line distance 214 by clicking or tapping on the device 204 along the line 214 to indicate a specific location for a fence post for a structure in the fence run, such as a gate in a selected location or the position of a desired post on a hip or valley in some non-limiting examples. In such a scenario, the device 204 will automatically divide and redistribute the segments of the run based on the operator's selections. In other words, the device 204 and the software stored and executed on the device 204 may interpret the location selected by the operator along the line 214 as additional markers and redistribute the fence post locations based on the above process.

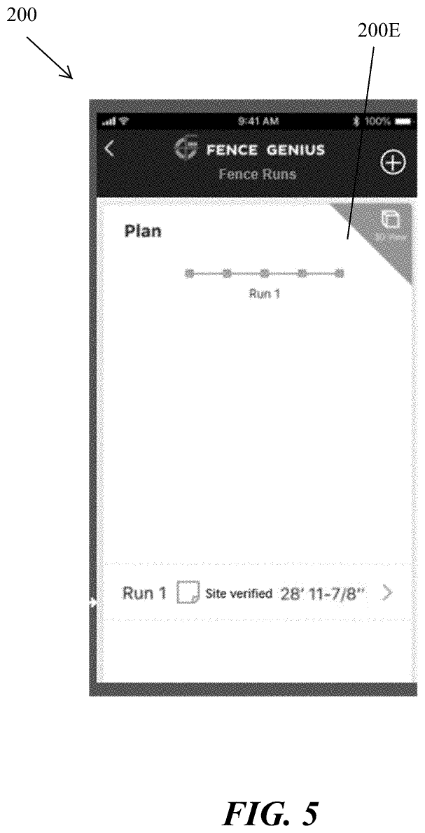

FIG. 5 is a fifth image 200E of the graphical user interface 200 that allows an operator to receive information regarding the straight line distance 214 of the fence run. Put a different way, the image 200E displays the distance 214 of each run after calculation of the distance 214 described with reference to FIG. 3 and FIG. 4 to the operator through the device 204 and graphical user interface 200. The operator can then repeat the above process for measuring each fence run in an entire fence system with all of the distances of the runs displayed in image 200E. Further, the device 204 stores the distance of each run, such that the user can access each run again in the future for further processing. Instead of repeating the steps above, the operator can also perform one continuous scan through a series of markers and the device 204 can create the runs for each set of markers and display the runs in image 200E in some implementations. More specifically, the operator can continue scanning the markers or the runs and the runs will continue to populate on the image 200E in FIG. 5 along with a plan view of the runs for a basic visual verification of the accuracy of the runs.

Once the operator and the device 204 calculate the distance of each fence run, the operator can exit the software program and access a web-based application to design a fence using the calculated fence run lengths and topography. The web-based application allows for input of special fence post locations for gates or trellises as well as selection of the characteristics of the fence, as described in U.S. patent application Ser. No. 16/932,490, the entire content of which is hereby incorporated herein by reference in its entirety. In some implementations, the device 204 transmits the LIDAR data, photogrammetry data, or any of the other types of data described herein, to the web-based application to assist with the fence design, such as to provide rough elevation data, horizontal distance data, panel length data, and post location data, to the web-based application to assist with fence design. The device 204 can then determine post heights based on the collected LIDAR or photogrammetry data regarding the topography of the terrain and the design requirements input by the operator through the web-based application. The determination of the run length can also be used in the web-based software to provide accurate estimates of the materials for a project. In areas along the straight line distance 214 where insufficient LIDAR or photogrammetry data is available, the web-based application or the device 204 can interpolate the available LIDAR data to estimate certain values, such as elevations or panel lengths, among other features. The estimated values can then be verified during additional processing, as described below.

The LIDAR data or photogrammetry data includes, in some implementations, elevation data and distance data between a series of markers. The software uses both of these data sets to create fence designs that vary the height of the fence components to accommodate undulations in the topography of the terrain. The software can, in some implementations, output the fence post height to attain the top of fence contour that is desired by the user and selected through the web-based application. The installation depth of the posts can be standard desired depths that are selected based on a number of factors, such as the installation site location as well as the features of the fence selected by the operator in the web-based application.

Alternatively, the operator can forego the proceeding processes and instead begin with a fence design in the web-based application in some implementations. Then, when the operator returns to the site and completes the scan, the device 204 will display the fence design to the operator in augmented reality, with the collected data from the process below confirming the fence post locations and characteristics.

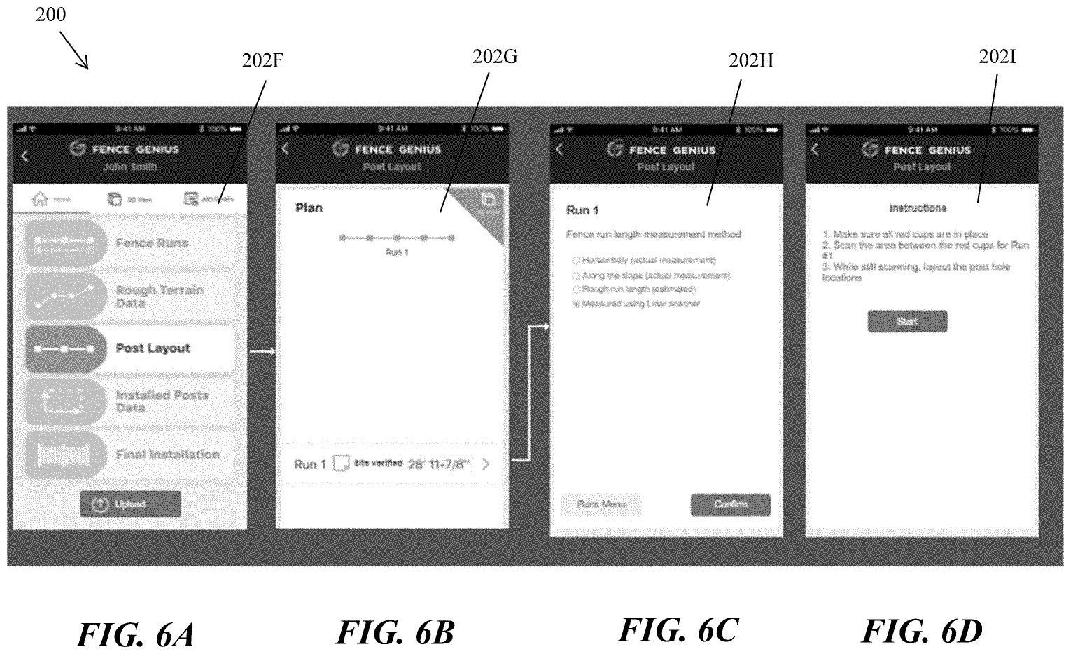

FIGS. 6A-6D show images of the graphical user interface 200 that requests input from the operator regarding how to measure and obtain the straight line distance 214 between markers 208, 212. Once the straight line distance 214 is calculated and the operator has selected their fence design using the web-based application (or if the operator begins with the fence design in the web-based application before scanning), the information from the web-based application is communicated to the device 204, as described herein. Then, the operator activates an additional functionality in the software to determine the fence post locations for a specific design, as shown in FIGS. 6A-6D.

Beginning with FIG. 6A, the user selects a “post layout” option as shown in image 202F. Selection of this option directs the operator to select a fence run for determination of the fence post location as shown in image 202G. The operator selects the appropriate fence run, which provides several options for measurement of the fence run length. In some implementations, the fence run length is already accurately captured, such as through the process described above. As such, this selection screen requests input from the operator as to how they are measuring to mark the fence post locations. The operator selects the appropriate measurement method in image 202H, which may be measurement by LIDAR or photogrammetry, in some implementations, and the interface 200 then provides a final instructions screen shown in image 202I. Each of the images 202F, 202G, 202H, 202I are optional, in some implementations, or the interface 200 may include additional options and images displayed to the operator.

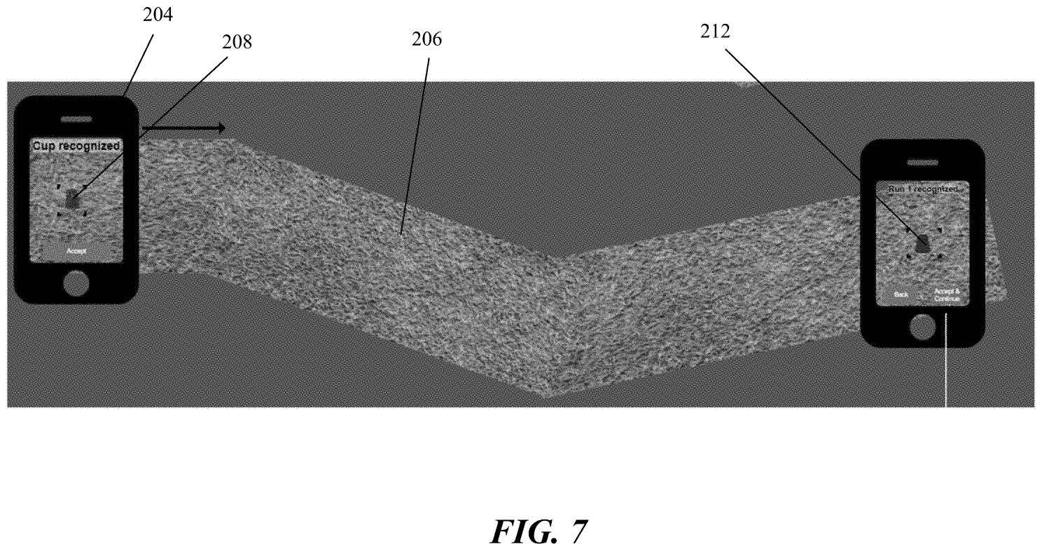

FIG. 7 is a schematic representation of a process for collecting data regarding the location and spacing of the fence posts and outputting the same to the operator. Specifically, once the operator selects the LIDAR or photogrammetry fence post location option described above in FIGS. 6A-6D, the device 204 will download the operator's fence design from the web-based application and display the design to the operator in augmented reality through the display of the device 204. If the operator selects a different method of measuring the fence post locations, then the device 204 may provide a static audible or visual indicator to the operator of the post locations to be marked, such as displaying or reading a distance to each post location from one of the markers 208, 212. The device 204 will then determine based on the previously collected LIDAR or photogrammetry data, as well as operator defined inputs, in some implementations, the characteristics of each fence post, such as fence post location, height and installation depth. In one or more implementations, the determination by the device 204 of the fence post locations includes interpolation of the previously collected LIDAR or photogrammetry data to fill in any areas with insufficient data.

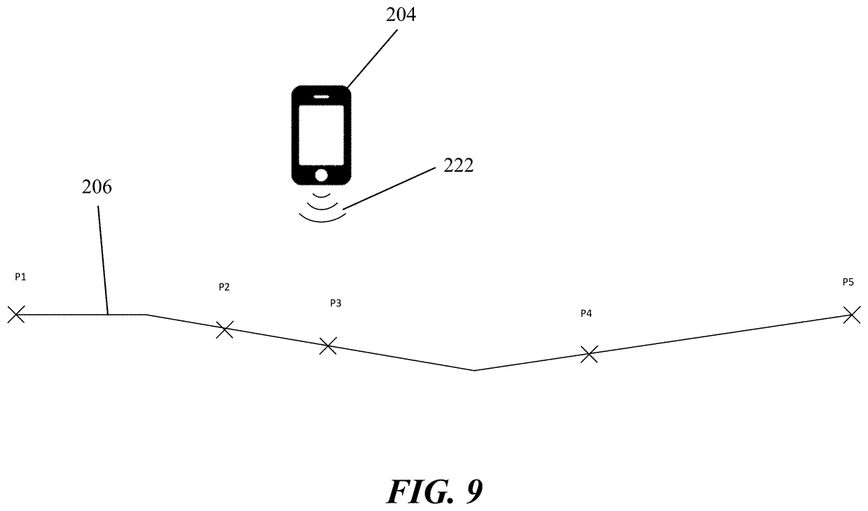

When using the LIDAR or photogrammetry options, the operator will return to one of the two markers 208, 212 for a given fence run. The device 204 will recognize the markers 208, 212 as described herein, and associate the markers 208, 212 with the indicated run of the fence design from the web-based application. Then, the device 204 will download the fence design and display the complete fence design to the operator through the device 204 based on the recognition of a previously recorded fence run. In addition, as the operator moves between the markers 208, 212 with the device 204, the device 204 will collect additional LIDAR or photogrammetry data about the ground characteristics, such as topography and potentially the location of any obstacles or other features of an environment that prevent installation of a fence run, in some optional implementations. The device 204 will also consider the location of specific fence posts, such as gate fence posts or the position of a desired post on a hip or valley, which may benefit from different installation characteristics relative to the other posts. FIG. 7 is a plan view of the grass 206. Collection of LIDAR or photogrammetry data corresponding to the topography of the grass 206 is explained with reference to FIG. 9.

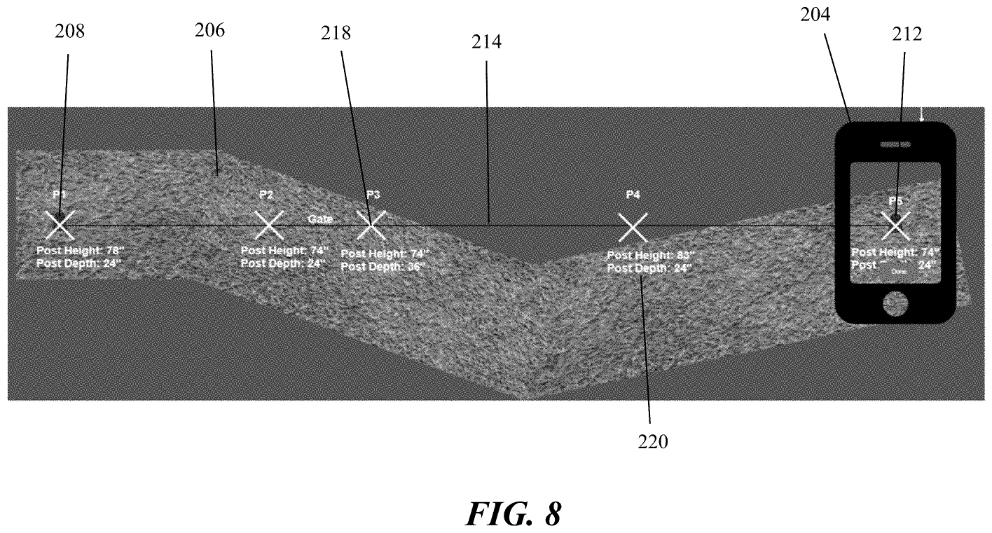

FIG. 8 is a schematic representation of a display of the software once two points of a known run are scanned in and recognized by the software. In other words, FIG. 8 represents the identification by the device 204 of a fence run and display of the fence system to the operator. In FIG. 8, the device 204 is positioned along the line 214 between markers 208, 212. Once the device 204 recognizes the markers 208, 212 and associates the markers 208, 212 with a previously scanned fence run, the device 204 will display the complete fence system to the operator in augmented reality on the device 204. The device 204 also calculates and displays, as explained above, the characteristics of each fence post, such as location, height, and installation depth in various implementations.

The display of the fence post characteristics to the operator is shown in FIG. 8 with indicators 218 placed along the fence run straight line distance 214. As above, the fence post height and the post installation depth may be optional and not included in some implementations. The indicators 218 are in a different location along the line 214 than the indicators 216 in FIG. 4 because the device 204 has calculated the actual or optimum fence post locations based on the operator's selected fence design as well as the topography of the grass 206. As above, the device 204 displays the indicators 218 to the operator through the display of the device 204 in augmented reality, in some implementations. The device 204 may also display additional fence post characteristics 220 at each indicator 218, such as the post number (i.e., P1-P5 in FIG. 8) as well as the post height and the post depth for each fence post in the run.

Moreover, the device 204 is continuously collecting data while the operator moves around the installation site, such that the fence post characteristics will continuously update as more data regarding the terrain is collected and analyzed. In some implementations, this process includes the device 204 confirming or updating any interpolations of the fence post characteristics 220. In one non-limiting example, if the device 204 did not collect sufficient LIDAR or photogrammetry data for post P4 in FIG. 8 during the initial scan, then the device 204 may interpolate that the post P4 in FIG. 8 should have a post height of seventy four inches. As the operator scans along the line 214 in FIG. 8, the device 204 may collect additional LIDAR or photogrammetry data regarding the location of post P4 and determine that, due to the slope of the grass 206 at P4, the post height should be eighty three inches, as shown in FIG. 8. Thus, the device 204 will update the fence post characteristics 220 for post P4 based on the additional data. Further, the device 204 displays different characteristics for each post. In one non-limiting example, the operator has selected a gate between posts P2 and P3. The operator may also select which post between posts P2 and P3 will be the hinge post for the gate, or the device 204 may default to one of the two posts P2 and P3 if no manual input is received from the operator. The hinge post for the gate may benefit from a deeper installation depth, such that the device 204 displays a deeper post depth for this post relative to the other post locations. For example, in FIG. 8, post P3 is selected as the hinge post and the device 204 displays a post installation depth of 36″ for post P3, which is greater than the installation depth of 24″ for the remaining posts.

In some implementations, the process includes only identifying and outputting the fence post locations 218 based on the determined straight line distance between the markers 208, 212, as described above. In implementations where the web-based application is used to design a specific fence system or to use a desired panel design, for example, then the process may optionally output the fence post height and installation depth.

Thus, in sum, one functionality of the systems and methods described herein is to perform a scan with the device 204 using software stored on the device and once two or more markers are identified, the device 204 will generate marking locations for the fence posts, such as indicators 216, along the determined fence run between the markers. The indicators 216 will automatically appear to the operator in real time as they continue to scan for additional markers based on algorithms and calculations made by the device 204 described herein. In some implementations, the operator can select specific post locations and the device 204 will automatically adjust the remaining post locations. An additional option is to upload the scan fence run data to the web-based software, further refine the design, and then return to scan at least two of the markers, at which point, all the scanned runs are displayed to the operator through augmented reality indicators. In this option, the systems and methods can optionally include an output to the operator of the fence post height and installation depth, in addition to the location of the fence posts. The fence post height and installation depth depend on the operator inputs to the web-based application as well as environmental factors, such as the topography of the terrain scanned by the device 204.

FIG. 9 is a schematic elevational representation of the process of FIG. 8. As referenced above, FIG. 8 is a plan view of the grass 206. FIG. 9 provides an elevational view to clarify the topography of the grass 206, represented in FIG. 9 by line 206. As the operator moves the device 204 along the grass 206 between the markers 208, 212 in a LIDAR scanning mode, the device 204 emits laser light pulses indicated by 222 toward the grass 206. The light pulses are reflected off the grass 206 back to the device 204 to be captured by the camera or other sensor of the device 204. The device 204 then determines, based on the time of flight of the emitted and received light pulses, the topography of the grass 206. For example, in FIG. 9, the light pulses 222 will take longer to reach the grass 206 and reflect back to the device at post P4 than at post P1 because of the difference in topography of the grass 206 at these locations. The device 204 then determines, based on the difference in time of flight, that there is a declining slope or depression in the ground surface at location P4 and takes this information into account in calculating the post characteristics 220. In some implementations, the device 204 may also include a GPS receiver that assigns GPS location information to the collected LIDAR data.

In a photogrammetry mode, the device 204 captures images indicated by 222 of the grass 206 and triangulates the topography based on the intersection of converging lines in space, assisted in some implementations by a bundle adjustment program. Triangulation enables a precise calculation of the topography of the grass 206. In some implementations, the device 204 may utilize both LIDAR and photogrammetry to determine the topography. For example, LIDAR may be used to generate an initial topography with photogrammetry used to verify accuracy or vice versa. The device 204 may also use both LIDAR and photogrammetry simultaneously to increase accuracy.

Further, the device 204 may include an accelerometer that collects data regarding the movement of the device during LIDAR or photogrammetry data collection. The accelerometer data can be used to correct for movement of the device 204 during collection of LIDAR or photogrammetry data. In one non-limiting example, if the device 204 is collecting LIDAR or photogrammetry data, or both, and the accelerometer detects movement of the device 204 by the operator up or down in the orientation shown in FIG. 9, the device can correct the LIDAR or photogrammetry data, or both, based on the detected movement of the device to ensure that the LIDAR or photogrammetry data is an accurate representation of the topography of the grass 206 and does not include errors due to movement of the device 204 by the operator.

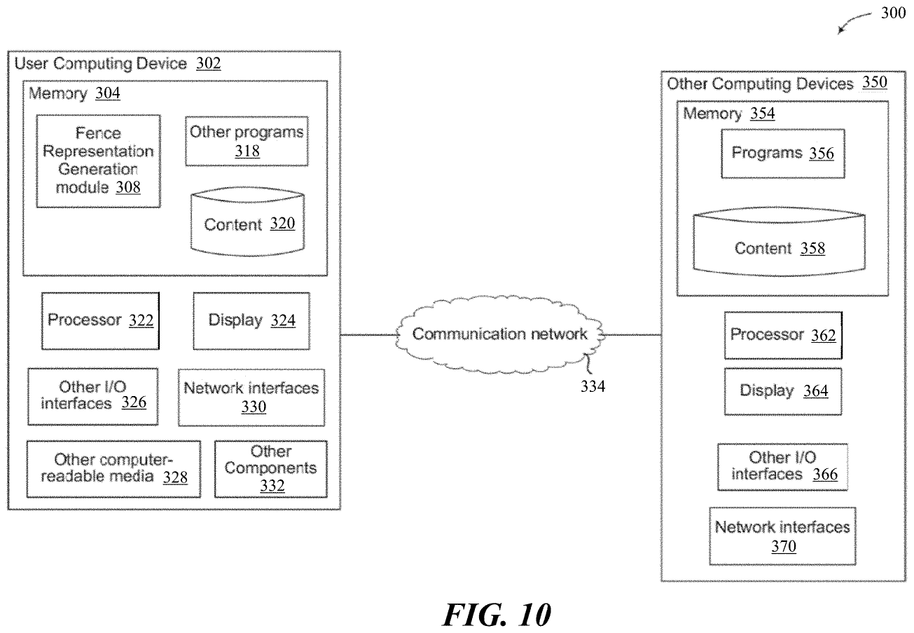

FIG. 10 shows a system diagram that describes one implementation of a computing system 300 according to the present disclosure for performing the implementations described herein. System 300 includes user computing device 302, and optionally one or more other computing devices 350. Implementations described herein may be executed by the user computing device 302, or they may be executed by the other computing devices 350 such that a user of the user computing device 302 accesses the functionality provided by the other computing devices 350.

User computing device 302 is a computing device that can perform functionality described herein for generating and presenting visual indicators, such as augmented reality representations, of fence post locations to a user and providing user interfaces that enable the user to dynamically select or modify one or more features or operations. One or more special-purpose computing systems may be used to implement the user computing device 302. Accordingly, various implementations described herein may be implemented in software, hardware, firmware, or in some combination thereof. The user computing device 302 includes memory 304, one or more processors 322, display 324, input/output (I/O) interfaces 326, other computer-readable media 326, network interface 330, and other components 332.

Processor 322 includes one or more processing devices that execute computer instructions to perform actions, including at least some implementations described herein. In various implementations, the processor 322 may include one or more central processing units (CPUs), programmable logic, or other processing circuitry.

Memory 304 may include one or more various types of non-volatile and/or volatile storage technologies. Examples of memory 304 include, but are not limited to, flash memory, hard disk drives, optical drives, solid-state drives, various types of random access memory (RAM), various types of read-only memory (ROM), other computer-readable storage media (also referred to as processor-readable storage media), or other memory technologies, or any combination thereof. Memory 304 may be utilized to store information, including computer-readable instructions that are utilized by processor 322 to perform actions, including at least some implementations described herein.

Memory 304 may have stored thereon various modules, such as fence representation generation module 308. The fence representation generation module 308 provides functionality to generate and update the fence design and to present one or more user interfaces to the user with the fence design in augmented reality, including the fence post characteristics.

Memory 304 may also store other programs 318 and other content 320. Other programs 318 may include operating systems, user applications, or other computer programs. Content 320 may include visual information regarding one or more fence panels, boards, rails, materials, colors, etc., as described herein. Further, the memory 304 may also store in the other programs 318 or content 320 instructions for activating the LIDAR functionality of the computing device 302, including activating the device 302 to emit laser light pulses and activating the camera or sensor of the device 302 to capture and store the received light pulses, as described herein. The device 302 may also include instructions for activation of LIDAR functionality based on user selections in the graphical user interface. The instructions may then be executed by the processor 322 to perform the functionality described herein.

The memory 304 may also store instructions or algorithms for making certain calculations described herein, such as calculation of the straight line distance between recorded reference points, interpolation of fence post characteristics based on surrounding data points, and determination of fence post height from the LIDAR data, among others.

Display 324 is a display device capable of rendering the visual representations and user interfaces to a user. In some implementations, the display 324 may include a touch screen in which the user can interact and input changes to one or more fence panel characteristics. The display 324 may be a liquid crystal display, light emitting diode, organic light emitting diode, or other type of display device, and may include a touch sensitive screen capable of receiving inputs from a user's hand, stylus, or other object.

I/O interfaces 326 may include interfaces for various other input or output devices, such as audio interfaces, other video interfaces, tactile interface devices, USB interfaces, physical buttons, keyboards, or the like.

Other computer-readable media 328 may include other types of stationary or removable computer-readable media, such as removable flash drives, external hard drives, or the like.

Network interfaces 330 are configured to communicate with other computing devices, such as the other computing devices 350, via a communication network 334. Network interfaces 330 include transmitters and receivers (not illustrated) or transceivers to send and receive data to and from other computing devices. In some implementations, the user computing device 302 may also be in communication with other devices (not illustrated), such as an electronic fence installation device (e.g., a computing device that determines a distance between posts, an elevation change between posts, a centerline angle between the posts, etc.), via network interfaces 320 or other I/O interfaces 326.

The communication network 334 is configured to couple various computing devices to transmit data from one or more devices to one or more other devices. Communication network 334 includes various wired or wireless networks that may be employed using various forms of communication technologies and topologies, such as, but not limited to, cellular networks, mesh networks, Wi-Fi®, Bluetooth® or the like.

The other computing devices 350 are computing devices that are remote from the user computing device 302, and in some implementations, can perform functionality described herein for generating and providing representations of fence panels to a user to enable the user to interact with one or more user interfaces to dynamically select or modify one or more fence panel characteristics. The other computing devices 350 may include a remote server, another user computing device, or some other computing device. In this way, a user of the user computing device 302 can access or utilize the other computing devices 350 to obtain the benefits described herein.

One or more special-purpose computing systems may be used to implement the other computing devices 350. Accordingly, various implementations described herein may be implemented in software, hardware, firmware, or in some combination thereof.

The other computing devices 350 include memory 354, one or more processors 362, display 364, I/O interfaces 366, and network interface 370, which may be similar to or incorporate implementations of memory 304, processor 322, display 324, I/O interfaces 326 and network interface 330 of user computing device 302, respectively. Thus, processor 362 includes one or more processing devices that execute computer instructions to perform actions, including at least some implementations described herein. In various implementations, the processor 322 may include one or more central processing units (CPUs), programmable logic, or other processing circuitry. Memory 354 may include one or more various types of non-volatile and/or volatile storage technologies.

Memory 354 may be utilized to store information, including computer-readable instructions that are utilized by processor 362 to perform actions, including at least some implementations described herein. Memory 354 may also store programs 356 and content 358. The programs 356 may include a fence representation generation module, not illustrated, similar to fence representation generation module 308 that generates and updates fence panel representations and presents one or more user interfaces to the user with the fence panel representations on display 324 of user computing device 302.

The software used to perform actions described herein can be run on any suitable computer hardware system, including a computer system having various input and output devices, a memory system, one or more processors (e.g., a central processing unit), one or more network connections, a display device, etc., with mobile phones and tablets being examples of suitable computer hardware. Thus, one or more computers execute computer instructions to perform implementations described herein. Moreover, the various implementations described herein may include the presentation of one or more graphical user interfaces to a user via a display device. In some implementations, the user may utilize one computing device to access a second, remote computing device, such as via a website or other remote connection, that is performing the implementations described herein.

Any of the software features or modules described herein can be linked to or integrated with other software packages and systems, such as to handle, manage, or perform administrative functions. For example, in some implementations, the software described herein can be integrated with CAD software packages such as AutoCAD, SolidWorks, with BIM software packages such as ArchiCAD, Trimble VICO office, or other construction business management software, such as CONSTRUCTOR software.

As such, implementations of the present disclosure enable use of a LIDAR instrument in combination with software for detecting and determining fence post layout and fence post characteristics in a fence run. The implementations of the present disclosure display various characteristics of the fence run and fence post characteristics to an operator through a graphical user interface of a device. Further, the device provides a visual indicator, such as an augmented reality representation, of the fence post locations and in some implementations, the fence post characteristics to enable more efficient and accurate fence layout and installation.

In the foregoing description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with the technology have not been shown or described in detail to avoid unnecessarily obscuring descriptions of the implementations. Additionally, the various implementations may be methods, systems, media, or devices. Accordingly, the various implementations may be entirely hardware implementations, entirely software implementations, or implementations combining software and hardware aspects. Unless the context requires otherwise, reference throughout the specification to “software” or “software system” refer to the functionality performed by or operations of computing devices, whether performed entirely by software, entirely by hardware, or a combination thereof.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its broadest sense, that is, as meaning “and/or” unless the context clearly dictates otherwise.

Any of the features described herein can be performed using computer systems activated by and interacted with via voice control and audio outputs rather than by direct physical interaction with a computer input device and/or visual output provided by a computer system.

Features and aspects of the various implementations and implementations described above can be combined to provide further implementations. All of the U.S. patents, U.S. patent application publications and U.S. patent applications referred to in this specification and/or listed in the Application Data Sheet are hereby incorporated herein by reference in their entireties. Aspects of the implementations can be modified, if necessary to employ concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled.

1. A method, comprising:
collecting data corresponding to a length of a fence run using a measurement device;
presenting a visual representation of the length of the fence run through a user interface;
collecting data corresponding to installation site characteristics along the fence run;
analyzing the data corresponding to the installation site characteristics to determine at least one of fence post spacing and fence post locations along the fence run; and
outputting the at least one of the fence post spacing and the fence post locations through the user interface, including providing a three-dimensional augmented reality visual representation of the at least one of the fence post spacing and the fence post locations along the fence run through the user interface.

2. The method of claim 1 wherein collecting data corresponding to the length of the fence run using the measurement device includes using one of a smart phone, tablet, and a wireless electronic device to collect the data.

3. The method of claim 1 wherein collecting data corresponding to the installation site characteristics includes collecting LIDAR data using a LIDAR sensor of the measurement device, the LIDAR data corresponding to a topography of the installation site.

4. The method of claim 1 wherein collecting data corresponding to the installation site characteristics includes collecting photogrammetry data using a camera of the measurement device.

5. The method of claim 4 further comprising:
analyzing the photogrammetry data, including determining a topography of the installation site using triangulation of converging lines in space based on the photogrammetry data.

6. The method of claim 1 wherein analyzing the data corresponding to the installation site characteristics includes determining fence post characteristics, the method further comprising:
outputting the fence post characteristics through the user interface, including providing a visual representation of at least one of fence post height and fence post installation depth through the user interface.

7. The method of claim 1 wherein collecting data corresponding to the length of the fence run includes analyzing the data corresponding to the length of the fence run to determine initial fence post spacing and initial fence post locations along the fence run, and
wherein analyzing the data corresponding to the installation site characteristics includes adjusting the initial fence post spacing and initial fence post locations based on the data corresponding to the installation site characteristics along the fence run to determine the fence post spacing and fence post locations along the fence run.

8. A computing device, comprising:
a memory configured to store computer instructions; and
at least one processor configured to execute the computer instructions to:
collect data corresponding to a length of a fence run at an installation site via a measurement device in electronic communication with the at least one processor;
determine a straight line distance between a first reference point and a second reference point along the length of the fence run;
collect at least one of LIDAR data and photogrammetry data with a sensor of the measurement device along the straight line distance;
analyze the at least one of the LIDAR data and the photogrammetry data to determine a location of one more fence posts along the straight line distance;
generate a visual representation of the location of the one or more fence posts along the straight line distance; and
display a graphical user interface to the user for receiving the visual representation of the location of the one or more fence posts along the straight line distance.

9. The computing device of claim 8 wherein the at least one processor is further configured to execute computer instructions to analyze the at least one of the LIDAR data and the photogrammetry data to determine fence post characteristics, the fence post characteristics being at least one of a fence post height and a fence post installation depth.

10. The computing device of claim 8 wherein the visual representation is an augmented reality indicator and the graphical user interface is displayed to the user on the measurement device.

11. The computing device of claim 8 wherein the measurement device is a smart phone, tablet, or a wireless electronic device including the sensor.

12. The computing device of claim 8 wherein the sensor is a LIDAR sensor and the at least one processor is configured to execute the computer instructions to collect the LIDAR data, the LIDAR data including topography information at the installation site.

13. The computing device of claim 8 wherein the sensor is a camera of the measurement device and the at least one processor is configured to execute the computer instructions to collect the photogrammetry data, the photogrammetry data including images captured by the camera and stored on the measurement device, the at least one processor further configured to execute computer instructions to:
determine a topography of the installation site by triangulating converging lines in space based on the photogrammetry data.

14. A computing device, comprising:
a memory configured to store computer instructions; and
at least one processor configured to execute the computer instructions to:
collect data corresponding to a length of a fence run at an installation site via a measurement device in electronic communication with the at least one processor;
determine a straight line distance between a first reference point and a second reference point along the length of the fence run;
analyze the data corresponding to the length of the fence run to determine at least one of fence post spacing and fence post installation locations along the fence run; and
display a graphical user interface to the user for receiving a three-dimensional augmented reality visual representation of the at least one of fence post spacing and fence post installation locations along the fence run.

15. The computing device of claim 14 wherein the at least one processor is further configured to execute computer instructions to:
collect at least one of LIDAR data and photogrammetry data from a sensor of the measurement device along the straight line distance;
analyze the at least one of the LIDAR data and the photogrammetry data to determine fence post characteristics along the straight line distance;
generate a visual representation of the fence post characteristics; and
display the graphical user interface to the user for receiving the visual representation of the fence post characteristics.

16. The computing device of claim 15 wherein the fence post characteristics are at least one of fence post height and fence post installation depth.

17. The computing device of claim 15 wherein the at least one processor is further configured to execute computer instructions to:
analyze the at least one of the LIDAR data and photogrammetry data to determine topography information of an installation site; and
adjust the at least one of the fence post spacing and fence post installation locations based on the topography information.

18. The computing device of claim 14 wherein the data corresponding to the length of the fence run is at least one of LIDAR data collected via a LIDAR sensor of the measurement device, photogrammetry data collected via a camera of the measurement device, and GPS data collected by a GPS receiver of the measurement device.

19. The computing device of claim 18 wherein the at least one processor is further configured to execute computer instructions to:
analyze the at least one of LIDAR data, photogrammetry data, and GPS data to determine topography information at the installation site.

20. The computing device of claim 14 wherein the measurement device is a smartphone or a tablet.
